(19) United States
(12) Patent Application Publication
(10) Pub. No.: US 2011/0307576 A1
(43) Pub. Date: Dec. 15, 2011

(54) CONTENT TRANSMITTING APPARATUS, CONTENT OUTPUT SYSTEM, TRANSMISSION CONTROL METHOD, TRANSMISSION CONTROL PROGRAM, AND RECORDING MEDIUM

(75) Inventors: Tadahiro Miyoshi, Ryugasaki (JP); Tomoe Nagata, Yokohama (JP)

(73) Assignee: PIONEER CORPORATION, Kanagawa (JP)

(21) Appl. No.: 13/202,889

(22) PCT Filed: Feb. 23, 2009
(86) PCT No.: PCT/JP2009/053204

§ 371 Date: Aug. 23, 2011

(51) Int. Cl. G06F 15/16

(52) U.S. Cl. 709/217

(57) ABSTRACT

A content output system (100) outputs by at least 1 content output apparatus (120), content data transmitted from a portable content transmitting apparatus (110). At the content transmitting apparatus (110), a transmitting unit (111) transmits the content data to a content output apparatus (120a) that is in a vicinity of the content transmitting apparatus (110). A sensing unit (112) during a state when the content data is being output to a first content output apparatus (120a), senses for a second content output apparatus (120b) that is in the vicinity consequent to transport of the content transmitting apparatus. The transmitting unit (111) transmits the content data such that output of the content data from the first content output apparatus (120a) and the content output apparatus (120b) occurs at an identical timing, if the second content output apparatus (120b) has been sensed.

### TECHNICAL FIELD

The present invention relates to a content transmitting apparatus, a transmission control method, transmission control program, and recording medium that transmit data to be output from a content output apparatus. Furthermore, the invention relates to a content output system that outputs by the content output apparatus, the content data transmitted from the content transmitting apparatus. However, use of the present invention is not limited to the content transmitting apparatus, the content output system, the transmission control method, the transmission control program, and the recording medium above.

### BACKGROUND ART

Conventionally, technology is known that stores content data, such as music, to a portable information terminal, such as a portable audio player and mobile telephone terminal, and plays the content data on the information terminal (see, for example, Patent Document 1). By using such a portable information terminal, a user can watch, listen to, and enjoy the content in a variety of places such as at house and in the car. Further, consequent to recent increases in the capacity of recording media, the type and amount of content data that portable information terminals can store has increased. As a result, the user can further enjoy content “what he likes, when he likes”.

For example, in Patent Document 1, metadata related to content data stored in a storage unit of a mobile device in a cradle or transmission data that is to be sent to a server apparatus and includes device information related to the mobile device is formed and transmitted to the server apparatus via the cradle. The server apparatus receives the transmission data transmitted from the mobile device via the cradle and performs processing according to the received transmission data, processing for utilization the content data, processing to grasp the utilization state of the content data, processing to grasp the utilization state of the mobile device, etc. to strengthen the coordination of the mobile device and the server apparatus and to further improve the usability of the mobile device, etc.

Patent Document 1: Japanese Patent Application Laid-Open Publication No. 2008-293631

### DISCLOSURE OF INVENTION

### Problem to be Solved by the Invention

Nonetheless, with the conventional technologies above, a problem arises in that, for example, when the user moves to another location while watching and/or listening to content, the user cannot continue to watch/listen to the content without the content output apparatus such as headphones and earphones being in continuous contact with the body. For example, if the content is music, many users use headphones while outside of the house and use speakers setup in the house while at home. For such users, after returning house, the user has to connect the information terminal to the speakers. Furthermore, if the user moves to another room while watching and/or listening to content, the user has to reconnect the information terminal to the speakers in the room to which he has moved.

Such operations are troublesome for the user and cause hiatuses in watching/listening to the content, potentially having a negative effect on the mood of the user. In other words, with the conventional technologies above, a problem arises in that, for example, a comfortable content viewing/listening environment cannot be provided to the user.

### Means for Solving Problem

To solve the problems above and achieve an object, a content transmitting apparatus according to claim 1 is portable and transmits content data to a content output apparatus. The content transmitting apparatus includes a transmitting unit that transmits the content data to a first content output apparatus that is within a vicinity of the content transmitting apparatus; and a sensing unit that during a state when the content data is being output to the first content output apparatus, senses for a second content output apparatus that is in the vicinity consequent to transport of the content transmitting apparatus. The transmitting unit transmits the content data to the first content output unit and the second output unit such that output of the content data by the first content output unit and the second output unit occurs at an identical timing, if the second content output apparatus has been sensed by the sensing unit.

A content output system according to claim 8 outputs to one or more content output apparatuses, content data transmitted from a portable content transmitting apparatus. The content transmitting apparatus includes a transmitting unit that transmits the content data to a first content output apparatus that is in a vicinity of the content transmitting apparatus, and a sensing unit that during a state when the content data is being output to the first content output apparatus, senses for a second content output apparatus that is in the vicinity consequent to transport of the content transmitting apparatus. The transmitting unit transmits the content data to the first content output unit and the second output unit such that output of the content data by the first content output unit and the second output unit occurs at an identical timing, if the second content output apparatus has been sensed by the sensing unit. Each content output apparatus includes a receiving unit that receives the content data transmitted by the content transmitting apparatus, and an output unit that outputs the content data received by the receiving unit.

A transmission control method according to claim 9, for controlling a content transmitting apparatus that transmits content data to a content output apparatus. The transmission control method includes a first transmitting step of transmitting the content data to a first content output apparatus that is in a vicinity of the content transmitting apparatus; a sensing step of sensing for a second content output apparatus that is different from the first content output apparatus and in the vicinity of the content transmitting apparatus, during a state when the content data is being output to the first content output apparatus; and a second transmitting step of transmitting the content data to the first content output unit and the second output unit such that output of the content data by the first content output unit and the second output unit occurs at an identical timing, if the second content output apparatus has been sensed by the sensing unit.

A transmission control program according to claim 10 causes a computer to execute the transmission control method according to claim 9.

A computer-readable recording medium according to claim 11, stores therein the transmission control program according to claim 10.

### BRIEF DESCRIPTION OF DRAWINGS

FIG. 1 is a block diagram of a functional configuration of a content output system according to an embodiment;

FIG. 2 is a flowchart of a content transmission process by a content transmitting apparatus;

FIG. 3 is a flowchart of a content output process by the content output apparatus;

FIG. 4 is a diagram of an overview of an audio system according to an example;

FIG. 5 is a block diagram of a hardware configuration of a portable audio player;

FIG. 6 is a block diagram of a hardware configuration of an audio output apparatus;

FIG. 7 is a flowchart of a music data transmission process executed by the portable audio player

FIG. 8 is a flowchart of a music data output process by the audio output apparatus; and

FIG. 9 is a flowchart of another music data transmission process by portable audio player.

### EXPLANATIONS OF LETTERS OR NUMERALS

100 content output system

110 content transmitting apparatus

111 transmitting unit

112 sensing unit

113 detecting unit

114 selecting unit

120, 120a, 120b content output apparatus

121 oscillating unit

122 receiving unit

123 output unit

### BEST MODE(S) FOR CARRYING OUT THE INVENTION

With reference to the accompanying drawings, preferred embodiments of a content transmitting apparatus, a content output system, a transmission control method, a transmission control program, and a recording medium according to the present invention will be described.

### Embodiment

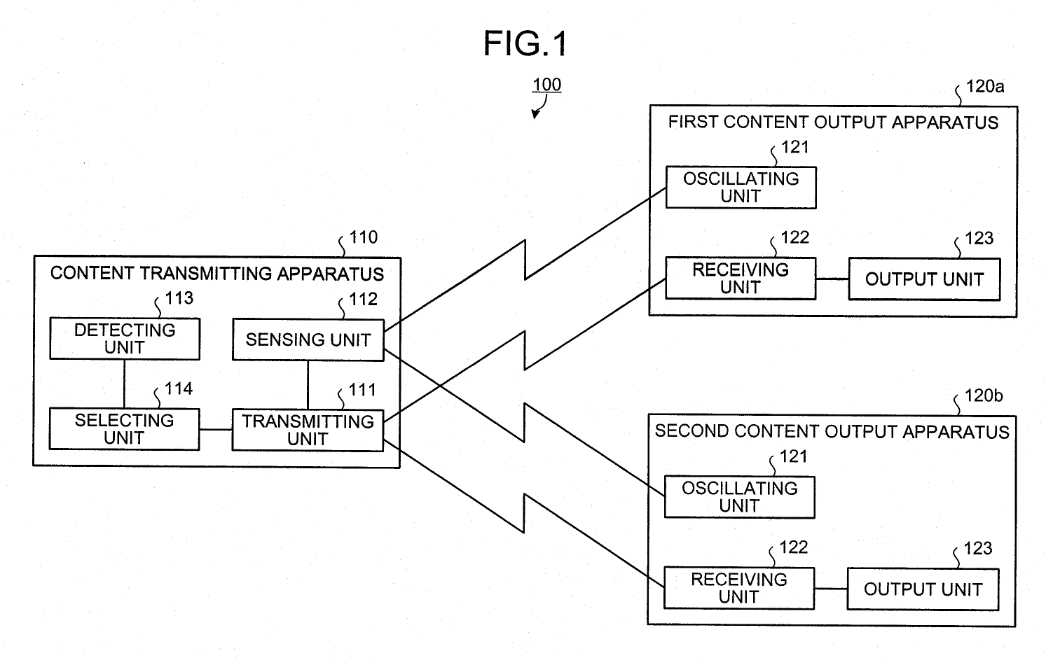

FIG. 1 is a block diagram of a functional configuration of a content output system according to an embodiment. A content output system 100 according to the embodiment outputs by at least one content output apparatus 120 (e.g., a first content output apparatus 120a, a second content output apparatus 120b), content data transmitted from a portable content transmitting apparatus 110.

More specifically, although the content transmitting apparatus 110 transmits content data to a nearby content output apparatus 120, since the content transmitting apparatus 110 is portable, the content output apparatus 120 that is nearby changes according to the movement (location) of the user. In such a case, the content transmitting apparatus 110 changes the destination to which the content data is output and transmits the content data to the content output apparatus 120 that is near the content transmitting apparatus 110. Consequently, even if the user moves while watching/listening to content, the user can continuously watch/listen to the content via the content output apparatus 120 that is nearby.

The content transmitting apparatus 110, specifically, for example, is a portable content playback device, a mobile telephone terminal, etc. and includes a transmitting unit 111, a sensing unit 112, a detecting unit 113, and a selecting unit 114. The transmitting unit 111 transmits content data to a content output apparatus 120 that is in a vicinity of (nearby) the content transmitting apparatus 110. If plural content output apparatuses 120 are in the vicinity of the content transmitting apparatus 110, the transmitting unit 111 transmits the content data to the content transmitting apparatuses 120 so that the content data is output from the content output apparatuses 120 at an identical timing.

The transmitting unit 111, for example, transmits to the content output apparatus 120, content data stored in the content transmitting apparatus 110, content data delivered via streaming from a content provider, broadcast content data received by a tuner, etc.

The transmitting unit 111 may be configured by plural wireless communications modules. In this case, when content data is transmitted to the content output apparatus 120, one wireless communications module corresponds to one content output apparatus 120 and the content data transmission is performed 1-to-1.

The sensing unit 112 senses a content output apparatus 120 that is in the vicinity of the content transmitting apparatus 110. More specifically, during a state when content data is being transmitted to a content output apparatus 120, the sensing unit 112 senses that another content output apparatus 120 is in the vicinity, consequent to the portability and transport of the content transmitting apparatus 110. Specifically, the sensing unit 112 receives a signal oscillated by the content output apparatus 120 to sense the content output apparatus 120.

The detecting unit 113 detects an attribute of the current position of the content transmitting apparatus 110. An attribute of the current position is, for example, outdoors, in a house, in a car, etc. Further, if the current position is in the house, configuration may be such that any one of the rooms in the house can be detected. The detecting unit 113, specifically, for example, detects the current position attribute by receiving an attribute-based signal that is output from an oscillator installed at the entrance of the house, of each room, of the car, etc.

The selecting unit 114, based on detection results obtained by the detecting unit 113, selects a content output apparatus (hereinafter, “preferential content output apparatus”) to which content data is preferentially transmitted. For example, if the content transmitting apparatus 110 is located in the house, the selecting unit 114 selects, as a preferential content output apparatus, a content output apparatus 120 that is installed in the house. Further, for example, if the content transmitting apparatus 110 is positioned in a given room in the house, the selecting unit 114 selects, as a preferential content output apparatus, a content output apparatus 120 that is installed in the given room. Moreover, for example, if the content transmitting apparatus 110 is positioned in the car, the selecting unit 114 selects, as priority content output apparatus, a content output apparatus 120 that is installed in the car.

Further, the content output apparatus 120, specifically, for example, is headphones, earphones, a speaker, a display, etc. and is a device that outputs content data in a form (such as sound or video) that can be watched/listened to by sensory organs of the user. In FIG. 1, although two content output apparatuses 120 (120a, 120b) are depicted, more than two of the content output apparatuses 120 can be used in the content output system 100.

The content output apparatus 120 is configured by an oscillating unit 121, a receiving unit 122, and an output unit 123. The oscillating unit 121 oscillates a signal. The signal oscillated by the oscillating unit 121 may be used by the content transmitting apparatus 110 for sensing, or for another use. Further, the oscillation of the signal from the oscillating unit 121 continues while the receiving unit 122 receives content data and the output unit 123 outputs the content data.

The receiving unit 122 receives content data transmitted by the content transmitting apparatus 110. The output unit 123 outputs the content data received by the receiving unit 122.

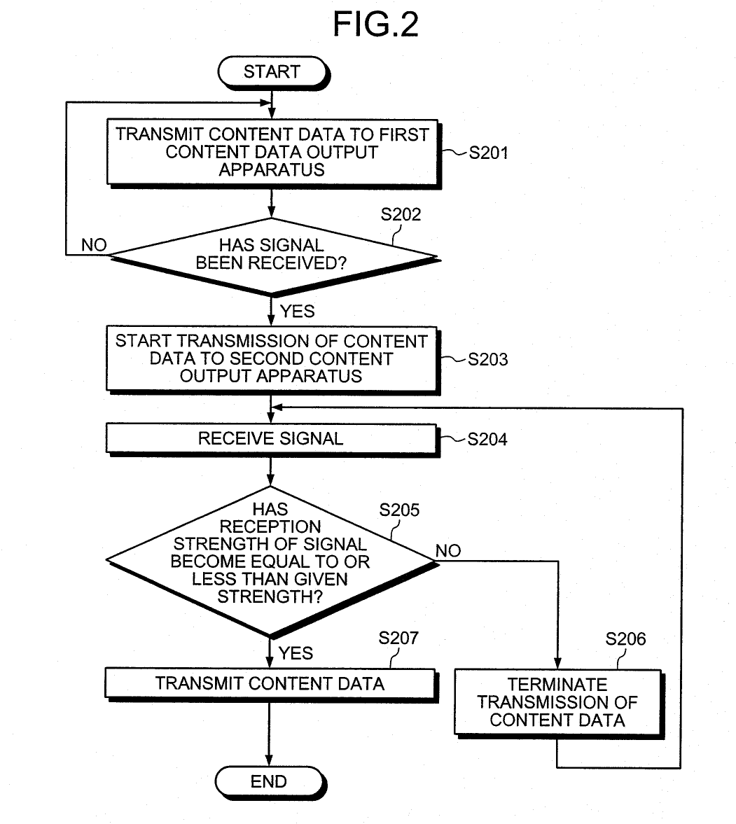

Next, processing by the content output system 100 will be described. FIG. 2 is a flowchart of a content transmission process by the content transmitting apparatus. The flowchart in FIG. 2 depicts a procedure that is performed when the transmission of content data to the second content output apparatus 120b starts while the content data is being transmitted to the first content output apparatus 120a.

In the flowchart in FIG. 2, the content transmitting apparatus 110 is transmitting content data to the first content output apparatus 120a (step S201). During this time, the position of the content transmitting apparatus 110 changes according to movement of the user. The content transmitting apparatus 110 returns to step S201 until a signal oscillated by the second content output apparatus 120b is received (step S202: NO) and continues to transmit the content data to the first content output apparatus 120a.

Upon receiving a signal oscillated by the second content output apparatus 120b (step S202: YES), the content transmitting apparatus 110 starts transmitting the content data to the second content output apparatus 120b (step S203). During this time, the transmission of the content data to the first content output apparatus 120a continues. More specifically, the content transmitting apparatus 110 transmits the content data to the first content output apparatus 120a and the second content output apparatus 120b so that the content data is output at an identical timing by the first content output apparatus 120a and the second content output apparatus 120b. Furthermore, the content transmitting apparatus 110 receives the signals oscillated by the first content output apparatus 120a and by the second content output apparatus 120b (step S204).

Next, the content transmitting apparatus 110 determines whether the reception strength of the signal received from the first content output apparatus 120a or from the second content output apparatus 120b is at most a given strength (step S205). If neither of the signals from the content output apparatuses 120 has a reception strength that is less than or equal to the given strength (step S205: NO), the content transmitting apparatus 110 continues to transmit the content data to the first content output apparatus 120a and to the second content output apparatus 120b (step S206), returns to step S204, and repeats the processes therefrom.

On the other hand, if any one of the signals from the content output apparatuses 120 has a reception strength that is less than or equal to the given strength (step S205: YES), the content transmitting apparatus 110 terminates transmission of the content data to the content output apparatus 120 for which the reception strength is less than or equal to the given strength (step S207), ending the processing according to the flowchart.

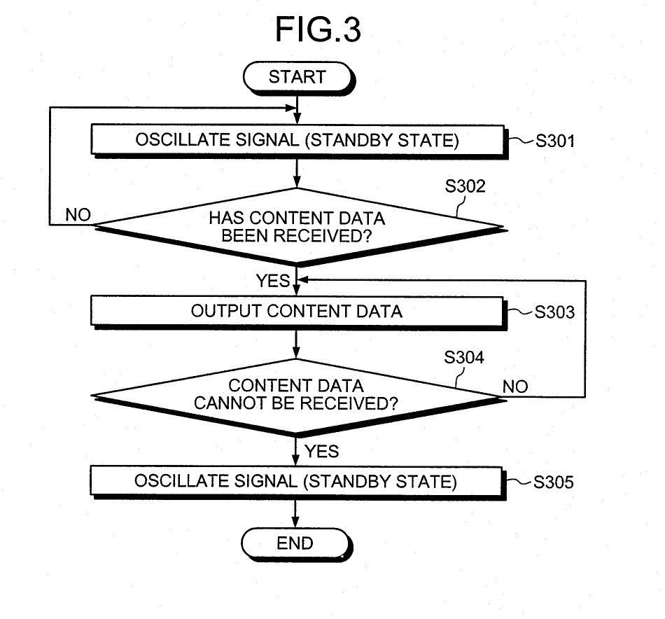

Next, processing at the content output apparatus 120 will be described. FIG. 3 is a flowchart of a content output process by the content output apparatus. In the flowchart in FIG. 3, the content output apparatus 120 oscillates a signal by the oscillating unit 121 (step S301). In this manner, a state in which only signal oscillation is performed is regarded as a standby state. The content output apparatus 120 returns to step S301 until content data transmitted from the content transmitting apparatus 110 is received (step S302: NO), and the standby state continues.

Upon receiving the content data (step S302: YES), the content output apparatus 120 outputs the received content data from the output unit 123 (step S303). During this time, oscillation of the signal by the oscillating unit 121 continues. Until the content data can no longer be received (step S304: NO), the content output apparatus 120 returns to step S303 and continues to output the content data.

When the content data can no longer be received (step S304: YES), the content output apparatus 120 enters the standby state and oscillates the signal via the oscillating unit 121 (step S305), ending the processing according to the flowchart.

As described, in the content output system 100, the content transmitting apparatus 110 senses a content output apparatus 120 that is in the vicinity while transmitting content data and further transmits the content data to the sensed content output apparatus 120. As a result, even if the content transmitting apparatus 110 moves to another location, the output of content data from a content output apparatus 120 in the vicinity can continue.

Further, the content transmitting apparatus 110 receives a signal oscillated by the content output apparatus 120 and if the reception strength of the signal becomes less than or equal to a given strength, the content transmitting apparatus 110 terminates transmission of the content data to the content output apparatus 120, whereby the transmission of the content data to the content output apparatus 120 whose distance from the content transmitting apparatus 110 has increased can be terminated and the content data can be transmitted to the closer content output apparatus 120.

Additionally, the content transmitting apparatus 110 detects an attribute of the current position thereof and can transmit content data to the content output apparatus 120 alone that is installed at the current position. Consequently, the content data is output from only the necessary content output apparatus 120, preventing audio interference and enabling a better content-viewing/listening environment to be provided to the user.

### Example

Hereinafter, an example of the invention will be described. In the example, output content in the content output system 100 is assumed to be music, a portable audio player is used as the content transmitting apparatus 110, and headphones and speakers are used as the content output apparatus 120.

### (Overview of Audio System 400)

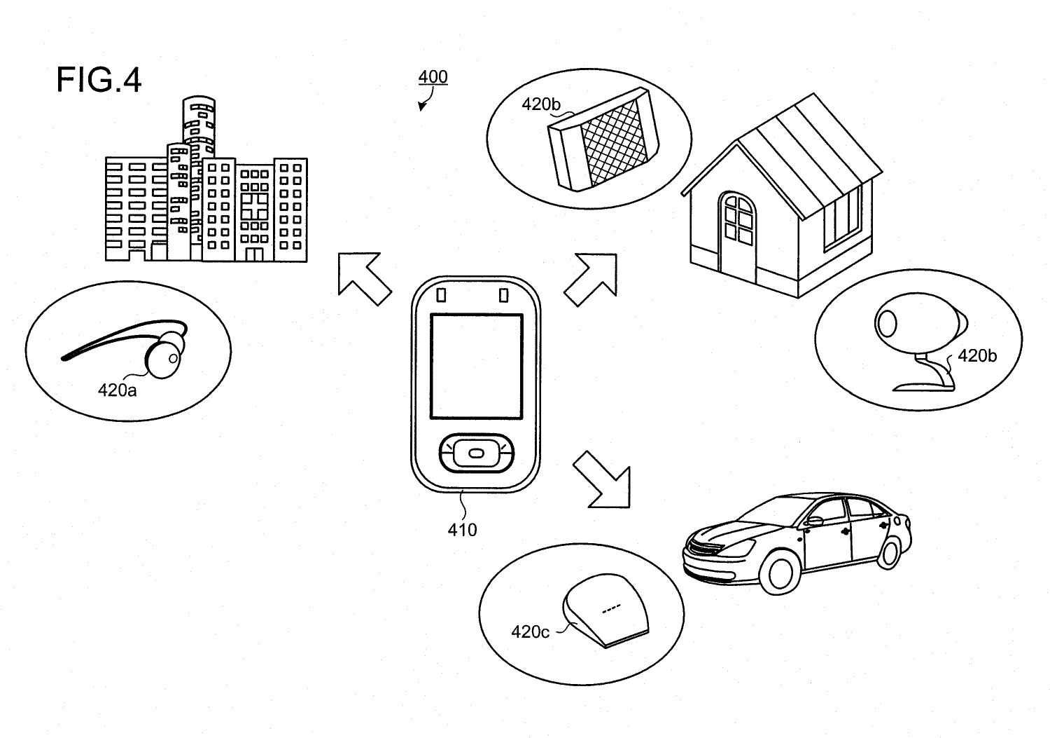

FIG. 4 is a diagram of an overview of an audio system according to the example. An audio system 400 according to the example is configured by a portable audio player 410 and an audio output apparatus 420. The audio output apparatus 420 is for example, a set of headphones 420a and speakers 420b, 420c.

The portable audio player 410 is an audio device capable of wireless communication. The portable audio player 410 stores and plays content data such as music, and further transmits the content data as audio data to the audio output apparatus 420. Audio data transmitted from the portable audio player 410 to the audio output apparatus 420 may be music data delivered by streaming from a content provider, music data received as a broadcast wave, etc.

The portable audio player 410, being portable, is transported by the user, whereby the position (location), e.g., in the house, in the car, in an urban area, etc., of the portable audio player 410 changes according to the movement of the user. Consequently, the portable audio player 410 senses for an audio output apparatus 420 that is in a vicinity of the portable audio player 410 and outputs audio data to the sensed audio output apparatus 420. A mobile telephone terminal may be used as the portable audio player 410.

As described above, the audio output apparatus 420 is, for example, the set of headphones 420a and the speakers 420b, 420c, and outputs, as sound, the audio data transmitted from the portable audio player 410. The audio output apparatus 420 remains in standby until the portable audio player 410 approaches to be within a vicinity of the audio output apparatus 420, upon which the audio output apparatus 420 outputs audio data that has been transmitted thereto.

In the audio system 400, for example, if the current position of the user is in an urban area, the headphones 420a are used as the audio output apparatus 420 to output audio data. Further, for example, if the current position of the user is in the house, the home-use speaker 420b is used to output the audio data. In FIG. 4, although only two speakers are depicted as the speakers 420b, by installing speakers in each of the rooms of the house and in each hallway, the user can listen to music without interruption while moving about in the house. Further, for example, if the current position of the user is in the car, the audio data is output from the car speaker 420c, as the audio output apparatus 420.

According to the current position of the user, the audio system 400 automatically switches the audio output apparatus 420 that is to output the music, whereby even if the user moves to another location, the user can continue to listen to the music without interruption. In other words, the audio system 400 can provide a seamless music listening environment to the user.

### (Hardware Configuration of Portable Audio Player 410)

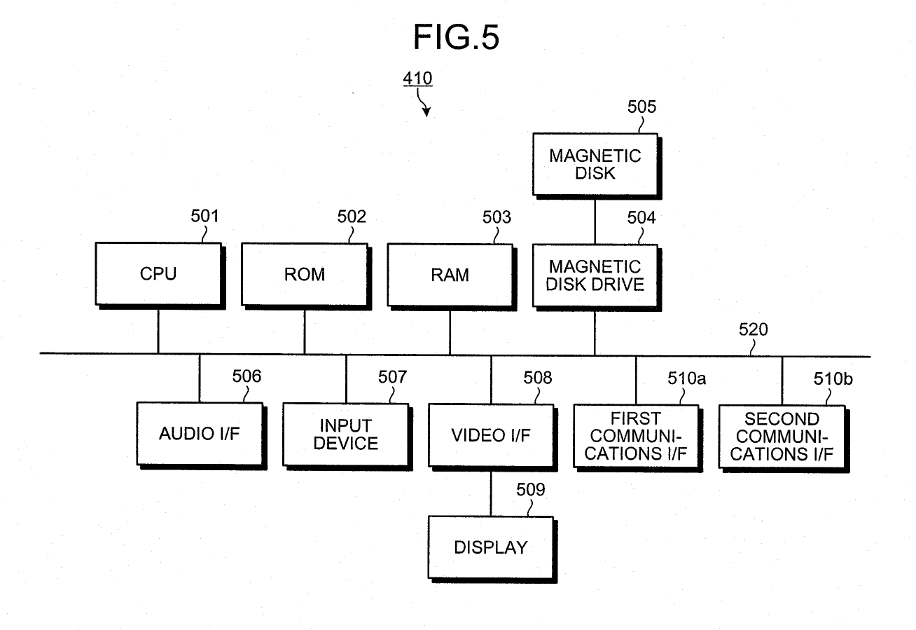

Next, a hardware configuration of the portable audio player 410 will be described. FIG. 5 is a block diagram of a hardware configuration of the portable audio player. In FIG. 5, the portable audio player 410 includes a CPU 501, ROM 502, RAM 503, a magnetic disk drive 504, a magnetic disk 505, an audio I/F (interface) 506, an input device 507, a video I/F 508, a display 509, a first communications I/F 510a, and a second communications I/F 510b, respectively connected by a bus 520.

The CPU 501 governs overall control of the portable audio player 410. The ROM 502 stores therein programs, such as a boot program and a communications control program. Further, the RAM 503 is used as work area of the CPU 501. In other words, the CPU 501 executes various types of programs stored in the ROM 502 while using the RAM 503 as a work area and thereby governs overall control of the portable audio player 410.

The magnetic disk drive 504, under the control of the CPU 501, controls the reading and writing of data with respect to the magnetic disk 505. The magnetic disk 505 stores data written thereto under the control of the magnetic disk drive 504. For example, a hard disk, a memory card, etc. can be used as the magnetic disk 505. The content data, such as music data, can be given as one example of the information stored to the magnetic disk 505.

Although not depicted, the portable audio player 410 may include flash memory. The flash memory is rewritable, removable, non-volatile semiconductor memory. The reading and writing of data with respect to the flash memory is controlled by the CPU 501. In the flash memory, for example, NAND flash memory, NOR flash memory, etc. can be used. The music information above, interval information formed by digest information in the music information, and information from which sound related to the music information originates are examples of the information stored to the flash memory. The flash memory may have a function of the ROM 502. In other words, the flash memory may store the various programs mentioned above.

The audio I/F 506 is a terminal for connecting the headphones and speakers, which are for audio output. In the present example, connection of the portable audio player 410 and the audio output apparatus 420 is by wireless communication, however, a cable through the audio I/F 506 may be used for the connection.

The input device 507 may be, for example, a remote controller, a keyboard, a touch panel, or like having keys used to input characters, numerical values, or various kinds of instructions. Further, the input device 507 may be implemented by any one, or more, of the remote controller, the keyboard, and the touch panel.

The video I/F 508 is connected to the display 509. The video I/F 508, specifically, for example, is configured by a graphic controller that controls the display 509, a buffer memory such as VRAM (Video RAM) that temporarily stores immediately displayable image information, and a control IC that controls the display 509 based on image data output from the graphic controller.

The display 509 displays icons, a cursor, menus, windows, or various data such as text and images. Text and image information related to the music information above may be drawn on the display 509. A liquid crystal display, for example, may be used as the display 509.

The first communications I/F 510a and the second communications I/F 510b use a wireless communications protocol, for example, Bluetooth (registered trademark), to perform wireless communication with audio output apparatuses 420 in the vicinity. Here, the two communications I/F (the first communications I/F 510a and the second communications I/F 510b) can be independent and communicate with different devices (specifically, the audio output apparatus 420). For example, when the first communications I/F 510a communicates with the headphones 420a, simultaneously the second communications I/F 510b can communicate with the speaker 420b. Further, for example, even if the first communications I/F 510a is communicating with the headphones 420a and the second communications I/F 510b does not find a communications counterpart, the portable audio player 410 attempts to find a communicable audio output apparatus 420. Consequently, even if the user moves to another location, output of the audio data to an audio output apparatus 420 that is in the vicinity can be continued.

Further, the first communications I/F 510a and the second communications I/F 510b are wirelessly connected to a communications network such as the Internet. Consequently, for example, content data can be downloaded from a content server on the Internet and can be received by streaming delivery. In the present example, although two communications I/F are provided, three or more communications I/F may be provided or one communications I/F may implement the communications I/F above.

The functions of the transmitting unit 111, the sensing unit 112, the detecting unit 113, and the selecting unit 114 of the content transmitting apparatus 110 depicted in FIG. 1 are implemented by using the programs and data stored to the ROM 502, the RAM 503 and the magnetic disk 505 of the portable audio player 410 depicted in FIG. 5, to execute a given program on the CPU 501 and control each of the units of the portable audio player 410.

### (Hardware Configuration of Audio Output Apparatus 420)

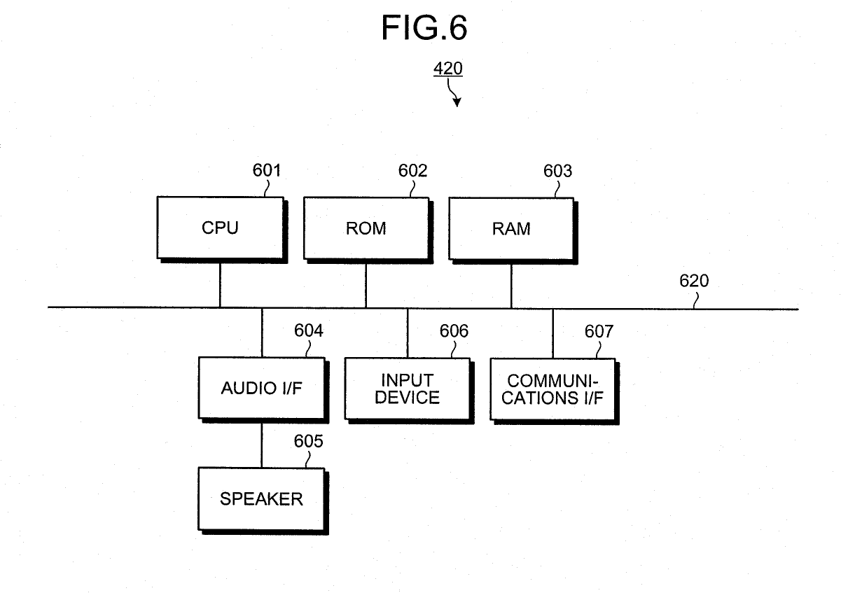

Next, a hardware configuration of the audio output apparatus 420 will be described. FIG. 6 is a block diagram of a hardware configuration of the audio output apparatus. In FIG. 6, the audio output apparatus 420 includes a CPU 601, ROM 602, RAM 603, an audio I/F (interface) 604, a speaker 605, an input device 606, and a communications I/F 607, respectively connected by a bus 620.

The CPU 601 governs overall control of the audio output apparatus 420. The ROM 602 stores therein programs such as a boot program and an audio control program. The RAM 603 is used as a work area of the CPU 601. In other words, the CPU 601 executes various types of programs stored to the ROM 602 while using the RAM 603 as a work area and thereby governs the overall control of the audio output apparatus 420.

The audio I/F 604 is connected to the speaker 605, which is for audio output. A given audio signal is D/A converted in the audio I/F 604 and output as sound from the speaker 605. Further, audio I/F 604 may be connected to, for example, two of the speakers 605, respectively for the right and left ears of the user.

The input device 606 may be, for example, a button-type operation unit, a dial-type operation unit, and a touch panel for inputting user instructions. The input device 606 may be implemented by any one or more of the button-type operation unit, the dial-type operation unit, and the touch panel.

The communications I/F 607, for example, uses a wireless communications protocol, for example, Bluetooth (registered trademark), to perform wireless communication with the portable audio player 410 in a vicinity of the audio output apparatus 420. The audio output apparatus 420 receives audio data from the portable audio player 410 via the communications I/F 607 and outputs the audio data as sound from the speaker 605 via the audio I/F 604.

Further, the communications I/F 607 transmits an oscillation signal to be sensed by the portable audio player 410. The strength of the oscillation signal transmitted by the communications I/F 607 is sensed to be stronger, the closer the distance is to the receiving device. The communications I/F 607 continues to transmit the oscillation signal, even while audio data is being received from the portable audio player 410.

The functions of the oscillating unit 121, the receiving unit 122, and the output unit 123 of the content output apparatus 120 depicted in FIG. 1 are implemented by using the programs stored to the ROM 602 and the RAM 603 of the audio output apparatus 420 depicted in FIG. 6, to execute a given program on the CPU 601 and control each of the units of the audio output apparatus 420.

### (Music Output Processing by Audio System 400)

Next, music output processing by the audio system 400 will be described. As described above, according to the current position of the user, the audio system 400 automatically switches the audio output apparatus 420 that is to output the music. Consequently, even if the user moves to another location, the user can continue to listen to the music without interruption.

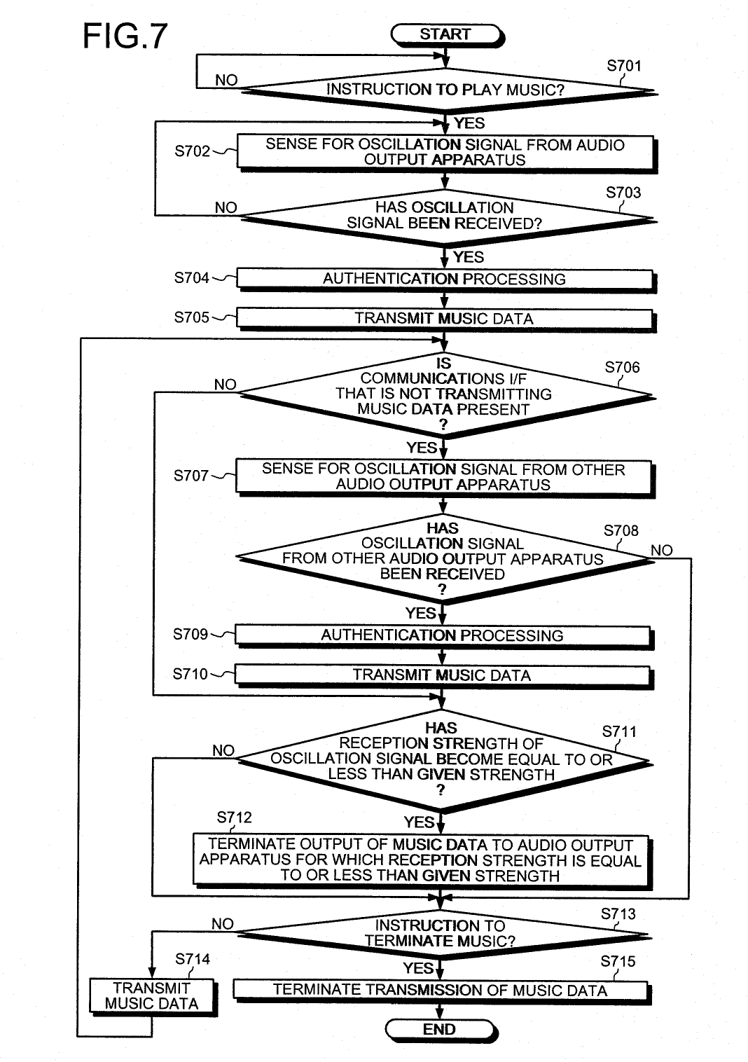

FIG. 7 is a flowchart of a music data transmission process executed by the portable audio player. In the flowchart depicted in FIG. 7, the portable audio player 410 remains in standby until an instruction to play music is received from the user (step S701: NO). Upon receiving an instruction to play music (step S701: YES), the portable audio player 410 senses for an oscillation signal from an audio output apparatus 420, using the first communications I/F 510a and the second communications I/F 510b (step S702).

Until an oscillation signal is received (step S703: NO), the portable audio player 410 returns to the step S702 and continues to sense for an oscillation signal. Here, reception of an oscillation signal is the reception of an oscillation signal that is of a strength equal to or greater than a given strength and indicates the sensing of an audio output apparatus 420 in the vicinity. Upon receiving an oscillation signal by the first communications I/F 510a or the second communications I/F 510b (step S703: YES), the portable audio player 410 performs authentication processing for the audio output apparatus 420 that has transmitted the received oscillation signal (step S704) and transmits music data via the communications I/F that has received the oscillation signal (step S705). At step S703, if the first communications I/F 510a and the second communications I/F 510b respectively receive an oscillation signal from discrete audio output apparatuses 420, authentication processing is performed for the audio output apparatuses 420, respectively, and music data is transmitted to the audio output apparatuses 420, respectively.

If a communications I/F that is not outputting music data is present (step S706: YES), the portable audio player 410 uses the communications I/F to sense for an oscillation signal from another audio output apparatus 420 (step S707). If all communications I/F are outputting music data (step S706: NO), the portable audio player 410 transitions to step S711.

If an oscillation signal is received from another audio output apparatus 420 (step S708: YES), the portable audio player 410 performs authentication processing for the audio output apparatus 420 (the speaker 420b) that has transmitted the received oscillation signal (step S709) and transmits the music data via the communications I/F that has received the oscillation signal (step S710). If an oscillation signal from another audio output apparatus 420 is not received (step S708: NO), the portable audio player 410 transitions to step S713.

Here, the music data transmitted from the first communications I/F 510a and the second communications I/F 510b is the same data. In other words, the portable audio player 410 is configured such that the music data transmitted by the first communications I/F 510a and the second communications I/F 510b is output simultaneously from the audio output apparatus 420 as the same sound. Here, the same data is that which includes data that has been compensated based on the respective characteristics of the two audio output apparatuses 420 such that the same sound is simultaneously output from the two audio output apparatuses 420.

Even while the portable audio player 410 is transmitting music data to an audio output apparatus 420, the portable audio player 410 continues to receive the oscillation signal from the audio output apparatus 420 to which the music data is being transmitted. If the reception strength of any one of the oscillation signals from the audio output apparatuses 420 becomes equal to or less than a given strength (step S711: YES), the portable audio player 410 terminates transmission of the music data to the audio output apparatus 420 for which the reception strength is equal to or less than the given strength (step S712). A decrease in the reception strength of an oscillation signal indicates that the distance between the audio output apparatus 420 and the portable audio player 410 (i.e., the user) has increased. Consequently, the portable audio player 410 terminates the transmission of music data to the audio output apparatus 420 to reduce power consumption (step S711: NO), and transitions to step S713.

Until an instruction to terminate music is received from the user (step S713: NO), the portable audio player 410 continues to transmit the music data (step S714), and returns to step S706 and continues the processes therefrom. If an instruction to termination music is received (step S713: YES), the transmission of the music data by the first communications I/F 510a and the second communications I/F 510b is terminated (step S715), ending the processing according to the flowchart.

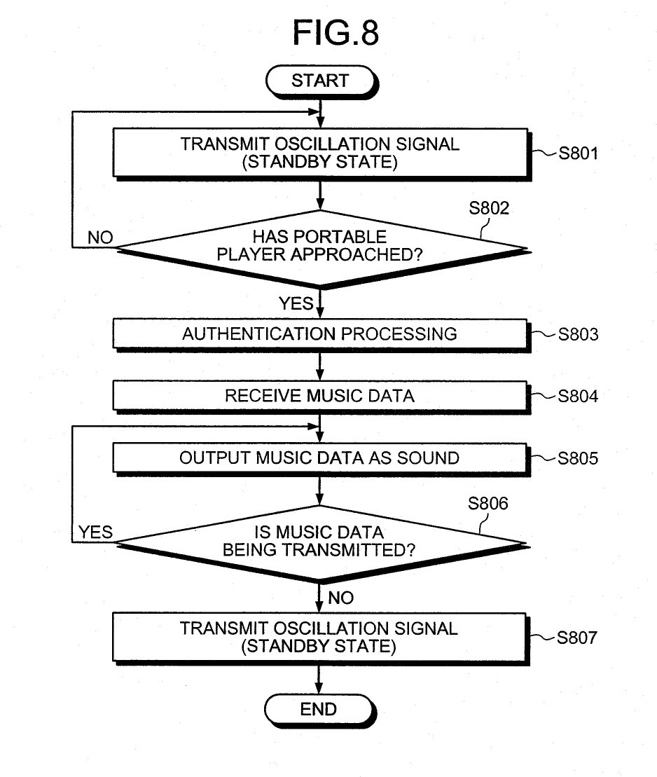

Next, processing at the audio output apparatus 420 will be described. FIG. 8 is a flowchart of a music data output process by the audio output apparatus. In the flowchart depicted in FIG. 8, the audio output apparatus 420 is in a standby state and only transmits an oscillation signal that is to be sense by the portable audio player 410 (step S801). Until a portable audio player 410 approaches to be within a vicinity of the audio output apparatus 420 (step S802: NO), the audio output apparatus 420 returns to step S801 and continues to remain in the standby state.

When a portable audio player 410 approaches to be within a vicinity of the audio output apparatus 420 (step 5802: YES), the audio output apparatus 420 performs authentication processing for the portable audio player 410 (step S803). Subsequently, the audio output apparatus 420 receives music data from the portable audio player 410 (step S804) and outputs, as sound, the received music data (step S805). The audio output apparatus 420 continues to output the oscillation signal even while receiving audio data from the portable audio player 410.

The audio output apparatus 420, while the music data is being transmitted from the portable audio player 410 (step S806: YES), returns to step S805 and continues to output the music data as sound. When the music data ceases to be transmitted from the portable audio player 410 (step S806: NO), the audio output apparatus 420 returns to the standby state of only transmitting the oscillation signal (step S807), ending the processing according to the flowchart.

As described, by processing such as that above, the audio system 400 automatically switches according to the current position of the user, the audio output apparatus 420 that is to output the music, whereby even if the user moves to another location, the user can continue to listen to the music without interruption.

Further, a priority level for each of the audio output apparatuses 420 that output the music may be determined depending on the current position of the user. For example, if the user is in the house, configuration may be such that the music data is transmitted only to the speaker 420b that is installed in the house, even if the headphones 420a are within a vicinity of the portable audio player 410. Consequently, power consumption of the portable audio player 410 can be reduced and audio interference between the headphones 420a and the speaker 420b can be prevented.

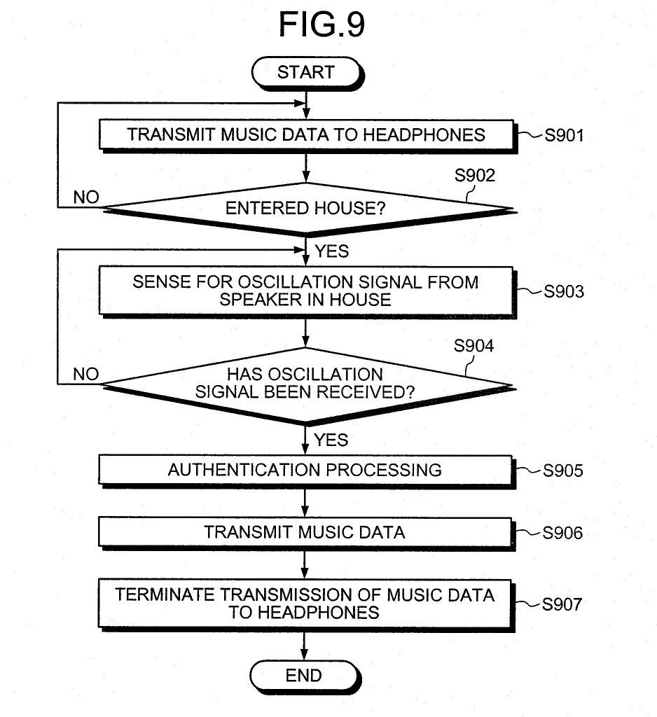

FIG. 9 is a flowchart of another music data transmission process by portable audio player. In the flowchart depicted in FIG. 9, a procedure that is performed when the user returns home is depicted. While the user is away from home, the portable audio player 410 transmits music data to the headphones 420a (step S901). Until the user enters the house (step S902: NO), the portable audio player 410 returns to step S901 and continues to transmit the music data to the headphones 420a.

When the user enters the house (step S902: YES), the portable audio player 410 senses for an oscillation signal from the speaker 420b installed in the house (step S903). Until the oscillation signal is received (step S904: NO), the portable audio player 410 returns to step S903 and continues sensing for the oscillation signal. Whether the user has entered the house, for example, is determined by whether an oscillation signal has been received from an oscillator provided at the entrance of the house.

When the oscillation signal is received by the first communications I/F 510a or the second communications I/F 510b (step S904: YES), the portable audio player 410 performs authentication processing for the speaker 420b that has transmitted the received oscillation signal (step S905), and transmits the music data via the communications I/F that received the oscillation signal (step S906). At step S904, if the first communications I/F 510a and the second communications I/F 510b respectively receive an oscillation signal from discrete speakers 420b, authentication processing is performed for the speakers 420b, respectively, and the music data is transmitted to the speakers 420b, respectively.

The portable audio player 410 terminates the transmission of the music data to the headphones 420a (step S907), ending the processing according to the flowchart. In this manner, even if the headphones 420a are in a vicinity of the portable audio player 410, if the user is in the house, the power consumption of the portable audio player 410 and audio interference between the headphones 420a and the speaker 420b can be prevented, by transmitting the music data to only the speaker 420b that is installed in the house. Similarly, if the user is in the car, configuration may be such that the music data is transmitted to only the car speaker 420c.

Further, for example, configuration may be such that even in the house, the current position of the user is detected and the music information is transmitted to only the speaker 420b that is in the room where the user is. For example, configuration may be such that if the user moves from room A to room B, while the user is in room A, sound is output from only the speaker 420b installed in room A; when the user moves through the hallway, sound is output from only the speaker 420b installed in the hallway; and when the user is in room B, sound is output from only the speaker 420b installed in room B.

In this case, for example, the portable audio player 410 preliminarily senses for the speaker 420b installed at the destination of the user and after movement of the user to the destination is sensed, the transmission of the music data is initiated. Further, for example, configuration may be such that the transmission of the music data to the speaker 420b at the destination is preliminarily initiated and after the speaker 420 detects that the user has entered the room, output of the music data begins. Furthermore, whether the user has entered a room is determined, for example, by whether an oscillation signal from an oscillator provided at the entrance of the room has been received.

As described, in the audio system 400, the portable audio player 410, even while transmitting music data, senses for an audio output apparatus 420 in the vicinity and transmits the content data (the music data) to the sensed audio output apparatus 420, whereby even if the portable audio player 410 (the user) moves to another location, the output of the music data from an audio output apparatus 420 in the vicinity can continue and the user can continue to listen to the music without interruption.

The portable audio player 410 receives signals oscillated by the audio output apparatuses 420 and terminates the transmission of music data to an audio output apparatus 420 for which the reception strength of the signal becomes equal to or less than a given strength. Consequently, the transmission of the music data to an audio output apparatus 420 whose distance from the portable audio player 410 has increased is terminated, enabling the power consumption of the portable audio player 410 to be decreased.

Further, the portable audio player 410 senses attributes of the current position thereof and can transmit music data to the audio output apparatus 420 alone that is installed at the current position. Consequently, music data is output from only the necessary audio output apparatus 420, preventing audio interference and enabling a better music listening environment to be provided. Furthermore, the power consumption of the portable audio player 410 and the audio output apparatus 420 can be reduced.

The transmission control method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the recording medium, and executed by the computer. The program may be a transmission medium that can be distributed through a network such as the Internet.

1-11. (canceled)

12. A content transmitting apparatus that is portable and transmits content data to a content output apparatus, the content transmitting apparatus comprising:
a transmitting unit that transmits the content data to a first content output apparatus that is within a vicinity of the content transmitting apparatus; and
a sensing unit that during a state when the content data is being output to the first content output apparatus, senses for a second content output apparatus that is in the vicinity consequent to transport of the content transmitting apparatus, wherein
the transmitting unit transmits the content data to the first content output unit and the second output unit such that output of the content data by the first content output unit and the second output unit occurs at an identical timing, if the second content output apparatus has been sensed by the sensing unit.

13. The content transmitting apparatus according to claim 12, wherein the sensing unit receives a signal oscillated by the second content output apparatus to sense the second content output apparatus.

14. The content transmitting apparatus according to claim 12, wherein
the sensing unit receives the signal from the first content output apparatus and from the second content output apparatus, and
the transmitting unit terminates transmission of the content data to any one among the first content output apparatus and the second content output apparatus for which reception strength of the signal has become equal to or less than a given strength.

15. The content transmitting apparatus according to claim 12, further comprising:
a detecting unit that detects an attribute of the current position of the content transmitting apparatus; and
a selecting unit that based on detection results obtained by the detecting unit, selects a preferential content output apparatus to which the content data is preferentially transmitted, wherein
the transmitting unit transmits the content data to the preferential content output apparatus alone.

16. The content transmitting apparatus according to claim 15, wherein
the detecting unit detects that the current position is in a house, and
the selecting unit selects as the preferential content output apparatus, the content output apparatus that is provided in the house.

17. The content transmitting apparatus according to claim 15, wherein
the detecting unit detects that the current position is in a given room in a house, and
the selecting unit selects as the preferential content output apparatus, the content output apparatus that is provided in the given room.

18. The content transmitting apparatus according to claim 15, wherein
the detecting unit detects that the current position is in a car, and
the selecting unit selects as the preferential content output apparatus, the content output apparatus that is provided in the car.

19. A content output system that outputs to one or more content output apparatuses, content data transmitted from a portable content transmitting apparatus, the content output system, wherein
the content transmitting apparatus comprises:
a transmitting unit that transmits the content data to a first content output apparatus that is in a vicinity of the content transmitting apparatus, and
a sensing unit that during a state when the content data is being output to the first content output apparatus, senses for a second content output apparatus that is in the vicinity consequent to transport of the content transmitting apparatus,
the transmitting unit transmits the content data to the first content output unit and the second output unit such that output of the content data by the first content output unit and the second output unit occurs at an identical timing, if the second content output apparatus has been sensed by the sensing unit, and
each content output apparatus comprises:
a receiving unit that receives the content data transmitted by the content transmitting apparatus, and
an output unit that outputs the content data received by the receiving unit.

20. A transmission control method of controlling a content transmitting apparatus that transmits content data to a content output apparatus, the transmission control method comprising:
transmitting the content data to a first content output apparatus that is in a vicinity of the content transmitting apparatus;
sensing for a second content output apparatus that is different from the first content output apparatus and in the vicinity of the content transmitting apparatus, during a state when the content data is being output to the first content output apparatus; and
transmitting the content data to the first content output unit and the second output unit such that output of the content data by the first content output unit and the second output unit occurs at an identical timing, if the second content output apparatus has been sensed by the sensing unit.

21. A non-transitory, computer-readable medium storing therein a transmission control program that causes a computer to execute the transmission control method according to claim 20.
